(19) United States
(12) Patent Application Publication
(10) Pub. No.: US 2024/0203141 A1
(43) Pub. Date: Jun. 20, 2024

(54) Photomicrographic image-processing method for automatic scanning, detection and classification of particles

(71) Applicants: Prithviraj Pralhad Jadhav; Sandeep Arvind Kulkarni

(72) Inventors: Prithviraj Pralhad Jadhav; Sandeep Arvind Kulkarni

(21) Appl. No.: 18/083,515

(22) Filed: Dec. 17, 2022

(51) Int. Cl. G06V 20/69; G02B 21/00; G02B 21/26; G02B 21/36; G06T 5/00; G06V 10/44

(52) U.S. Cl. CPC G06V 20/693; G02B 21/0036; G02B 21/008; G02B 21/26; G02B 21/365; G06T 5/002; G06V 10/44; G06V 20/695; G06T 2207/10056

(57) ABSTRACT

Disclosed herein is a computer-assisted photomicrographic image-processing method for automatic scanning, detection and classification of particles. In this method, tracking and analysis of objects of interest (namely, particulates), if any present and seen in one or more photographic images of the sample being analyzed, can be conveniently and rapidly undertaken on the basis of automated computational logic so provisioned.

Cross references to related applications: This non-provisional patent application claims the benefit of U.S. provisional application No. 63/291,360 filed on 18 Dec. 2021, the contents of which are incorporated herein in their entirety by reference.

Statement Regarding Federally Sponsored Research or Development: None applicable

Reference to Sequence Listing, a Table, or a Computer Program Listing Compact Disc Appendix: None

### FIELD OF THE INVENTION

This invention relates generally to the field of image processing and particularly to applications thereof for qualitative and quantitative analyses. Specifically, a microphotography method and its implementing system are disclosed in this paper, whereby a sample presented on a microscopic slide is scanned by means of a software-controlled motorized stage to thereby allow the detection and classification of particles, if any present in said sample, from one or more field(s) of view.

### BACKGROUND OF THE INVENTION AND DESCRIPTION OF RELATED ART

Image processing generally refers to digitization of optical images, and performing operation(s) on the so-converted data to augment and/or extract further meaningful information, preferably in an automated manner. Signal dispensation of source data, approach for processing said input source data and interpretation of post-processing output are major areas of interdisciplinary research in field of the present invention wherein image visualization, restoration, retrieval, measurement and recognition are prime loci of progressive investigation.

Particle analysis and particle characterization are major areas of research in new drug or formulation development in pharmaceutical industry. A proper analysis of particle size and shape reduces development time to a great extent. However, most of the current microscopic analysis is done manually which requires more time besides being prone to subjective interpretation and requires an expert to take the decision.

Processing of photomicrographic images, in above parlance, is found to be employed variably in state-of-art technologies for study of microscopic particles wherein identifying indicia among their physical, chemical, compositional, morphological attributes and/or physiological behaviors are utilized for qualitative and/or quantitative determinations including identification and size distribution of the particles under study. However, such implements are presently limited to non-visual light microscopy applications such as X-ray microtomography (CT), transmission electron microscopy (TEM), scanning electron microscopy (SEM) and the like. Therefore, it would be advantageous to have some means for availing advantages of image processing technology for visual light/optical microscopy, particularly particle analysis applications.

Conventionally, detection and classification of particles has been practiced via sieving, sedimentation, dynamic light scattering, electrozone sensing, optical particle counting, XRD line profile analysis, adsorption techniques and mercury intrusion or further indirect methods such as surface area measurements. However, resolution of these techniques leave a lot to be desired, besides relying on availability of expensive equipment and collateral prior expertise of skilled operators for arriving at the determination intended. Such analysis, as will be obvious to the reader, tends to be less reproducible due to unavoidable personal biases and therefore inaccurate for faultless determinations. There is hence a need for some way that makes possible the integration of image analytics for particle classification in optical microscopy applications.

The art therefore requires a particle identification and classification technology that is capable of plug-and-play integration in existing optical microscopy application environments with minimal bias on capital, integration and operative expenses and at the same time, being of a nature that allows accurate and precise implementation by any person even ordinarily skilled in the art. Ability to succinctly discern despite strong variability among objects of interest, low contrast, and/or high incidence of agglomerates and background noise are additional characters desirable in said particle identification and classification technology presently lacking in state-of-art.

Prior art, to the limited extent presently surveyed, does not list a single effective solution embracing all considerations mentioned hereinabove, thus preserving an acute necessity-to-invent for the present inventors who, as result of their focused research, have come up with novel solutions for resolving all needs of the art once and for all. Work of the presently named inventors, specifically directed against the technical problems recited hereinabove and currently part of the public domain including earlier filed patent applications, is neither expressly nor impliedly admitted as prior art against the present disclosures.

A better understanding of the objects, advantages, features, properties and relationships of the present invention will be obtained from the underlying specification, which sets forth the best mode contemplated by the inventor of carrying out the present invention.

### OBJECTIVES OF THE PRESENT INVENTION

The present invention is identified in addressing at least all major deficiencies of art discussed in the foregoing section by effectively addressing the objectives stated under, of which:

It is a primary objective to provide an effective method for photomicrographic image-processing method for automatic scanning, detection and classification of particles present in a sample presented for photomicrography.

It is another objective further to the aforesaid objective(s) that the method so provided is error-free and lends itself to accurate implementation even at hands of a user of average skill in the art.

It is another objective further to the aforesaid objective(s) that implementation of the method so provided does not involve any complicated or overtly expensive hardware.

It is another objective further to the aforesaid objective(s) that implementation of the method is possible via a remote server, in a software-as-a-service (SaaS) model.

The manner in which the above objectives are achieved, together with other objects and advantages which will become subsequently apparent, reside in the detailed description set forth below in reference to the accompanying drawings and furthermore specifically outlined in the independent claims. Other advantageous embodiments of the invention are specified in the dependent claims.

### BRIEF DESCRIPTION OF THE DRAWINGS

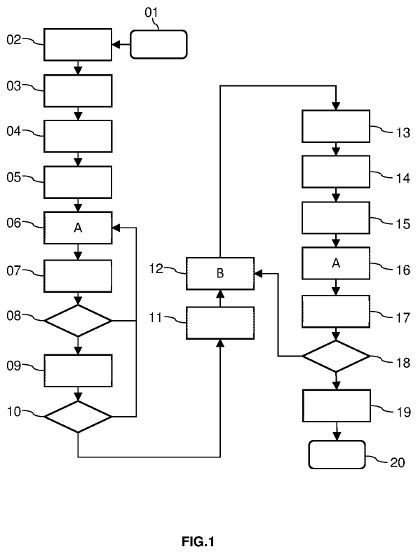

The present invention is explained herein under with reference to the following drawings, in which-FIG. 1 is a flowchart explaining the process sequence logic of the present invention.

The above drawings are illustrative of particular examples of the present invention but are not intended to limit the scope thereof. In above drawings, wherever possible, the same references and symbols have been used throughout to refer to the same or similar parts. Though numbering has been introduced to demarcate reference to specific components in relation to such references being made in different sections of this specification, all components are not shown or numbered in each drawing to avoid obscuring the invention proposed.

Attention of the reader is now requested to the brief description to follow which narrates a preferred embodiment of the present invention and such other ways in which principles of the invention may be employed without parting from the essence of the invention claimed herein.

### SUMMARY OF THE INVENTION

The present invention is directed to a photomicrographic image-processing method for automatic scanning, detection and classification of particles present in a sample presented for photomicrography, using a microscope having a motorized stage which is fitted with an imaging system such as a camera.

### DETAILED DESCRIPTION

Principally, general purpose of the present invention is to assess disabilities and shortcomings inherent to known systems comprising state of the art and develop new systems incorporating all available advantages of known art and none of its disadvantages.

Specifically as to the hardware involved, the execution environment of the present invention involves an optical microscope having a target object for visualization, to which an imaging system such as a digital camera is associated in a manner allowing capturing of magnified imagery of the object seen via said microscope. Thus, in the recital herein, the reader shall understand that images referred for analysis are ones obtained from said microscope as captured by the camera.

The target object referred above is a typically a slide bearing a sample thereon. The sample to be analyzed is prepared using standard laboratory techniques and placed on a motorized slide stage of the microscope for photomicrography.

Fitment of the camera to the microscope, as mentioned above, is done via suitable fitments, brackets etcetera, used conventionally for said purpose. Captured images of the camera are captured on a memory device (such as a memory card) housed in said camera and said data is conveyed subsequently Or in real time, via a data cable, to a personal computer for further processing.

Data output of the camera is received and processed by means of an application of the present invention (named “ipvAutoClass” and referred so throughout this document) being priorly installed on said personal computer. Alternatively, ipvAutoClass may be hosted on the cloud, and made available in the SaaS model of implementation (that is, the executable software is provisioned for execution on the computer by either between a standalone installation and online access from a cloud server in a software-as-a-service model).

As will be realized further to the disclosures above, resolution of the present invention is correlated with optics of the microscope, and not the camera or computing system involved. Camera fitments for optical microscopes are inexpensive and commonly available. Assemblage and operations of these components requires no particular skill or collateral knowledge. Hence, the present invention is free of constraints entailing otherwise from capital, operation and maintenance costs besides negating the requirement of trained skilled operators for implementation of the present invention.

General logic for implementation of the present invention is now described with reference to FIG. 1 accompanying these presents, wherein an exemplary use-case of the present invention is described herein after in format of a standard operating protocol of ipvAutoClass intended to be executed by the user, said protocol being manifested via different interactive user interfaces programmed within ipvAutoClass.

As seen in FIG. 1, foremost, the user (technician) initializes/starts ipvAutoClass (01), to trigger the presentation of an initial interface via which the user is prompted (via suitable on-screen controls) to create/select method to set particle range, magnification selection etcetera (02). Once this is done, a second interface is manifested in which an image of the slide is simulated to allow the user to select the scan position by marking, on screen, a rectangular area to be scanned (03).

Once the scanning position and scanning area are defined as per foregoing narration, ipvAutoClass computes (04), in the background, the actual number of fields (rows and columns) to be captured in the area marked for scanning, actual area on slide, apropos the magnification and captured image resolution selected during the first step mentioned above.

Once the aforesaid mapping is done, a sub-function of the ipvAutoClass labelled AutoScanner is triggered, which computes (05) actual initial position and moves the scanner X and Y position on the slide. AutoScanner follows a basal program to move (06; Labeled “A”) the motorized slide stage in Z direction in steps and captures multiple images at different Z positions. Next, AutoScanner computes the optimum sharpness of the images and sets the Z movement at the most focused (optimum) position. Lastly, AutoScanner saves (07) the image in shared folder with its Row and column position in the image name. Moves slide to left by one step of the computed field of view.

There subsequently, ipvAutoClass performs a series of validations as below—
a) A first validation (08) is to determine whether the current position is the Last X position—if yes, AutoScanner moves (09) the motorized slide stage in Y direction, however if not, AutoScanner reverts to its basal program (06) mentioned hereinabove.
b) A second validation (10) is to determine whether the current position is the Last Y position—if yes, AutoScanner reads (11) image from shared folder, however if not, AutoScanner reverts to its basal program (06) mentioned hereinabove.

If determination in validation step b) above is in the affirmative, ipvAutoClass progresses to a next step in which the image is read (11) from the shared folder and smoothened (12; Labeled “B”) by removing noise. Thereafter, contours in said image are identified (13) and contours of same gray value variation (gradient) are mapped out for object identification, in a downstream process.

Aforementioned contour-based mapping is used to identify objects (14), and further characterize/refine choice by selecting best contour from group from user criteria selection (Sharpness, Bounding box, Circularity, and Perimeter). Once objects are identified, feature computation is undertaken (15) on basis of size, shape, color, and texture. Thereafter, pre-arranged/pre-programmed filters are applied (16) to remove artifacts. Filters applied are selected among group including a) size filter—Filter Particles not in defined range; b) Sharpness Filter—Filter blur particles (less than defined sharpness); and c) Agglomeration Filter—Filter non isolated particles identified on shape features.

Once filtered data is available, ipvAutoClass is programmed to progress into classification (17) of particles as per user defined types (API, Globule, excipient etc) and/or defined particle range according to which corresponding thumbnail image is shown in the scanned area.

There subsequently, ipvAutoClass performs a last validation (18), to determine if the image being processed is last image of total fields. If in affirmative, ipvAutoClass computes (19) and presents result statistics of the analysis undertaken to conclude (20) the operational cycle. If in the negative however, the progression is looped back to the stage (12) of preprocessing/noise removal until obtaining a discernable accurate result.

In the embodiment recited herein, the reader shall presume that images referred are ones obtained from a microscope having a motorized stage which is fitted with an imaging system such as a camera. For this, a sample to be analyzed is processed using standard microscopy sample preparation and taken on stage of microscope for microphotography. As will be realized further, resolution of the present invention is correlated with optics of the microscope, and not the camera or computing system involved. Camera fitments for optical microscopes are inexpensive and commonly available. Assemblage and operations of these components requires no particular skill or collateral knowledge. Hence, the present invention is free of constraints entailing otherwise from capital, operation and maintenance costs besides negating the requirement of trained skilled operators for implementation of the present invention.

As will be realized further, the present invention is capable of various other embodiments and that its several components and related details are capable of various alterations, all without departing from the basic concept of the present invention. Accordingly, the foregoing description will be regarded as illustrative in nature and not as restrictive in any form whatsoever. Modifications and variations of the system and apparatus described herein will be obvious to those skilled in the art. Such modifications and variations are intended to come within ambit of the present invention, which is limited only by the appended claims.

We claim:

1. A photomicrographic image-processing method for automatic scanning, detection and classification of particles present in a sample presented for photomicrography, comprising—
a) Constituting an application environment by communicatively associating an optical microscope having a motorized stage to a computer, wherein—
The photomicrographic image-processing method for automatic scanning, detection and classification of particles present in a sample presented for photomicrography is provisioned for execution, as an executable software, on said computer; and
the optical microscope is outfitted with a digital camera for capturing images from the field of view of said microscope and relaying said captured images in real time to said computer for processing by the executable software provisioned on said computer.
b) Defining at instance of the user via a computer user interface of the executable software, a set of scanning parameters being opted among particle size, analysis area, scan position, captured image resolution, and magnification;
c) Marking at instance of the user, via a computer user interface of the executable software simulating an image of the slide, a rectangular area to be scanned;
d) In accordance with logic of the executable software, causing the execution of an AutoScanner subroutine programmed within the executable software, said subroutine comprising the steps of—
Computing the actual number of fields in terms of rows and columns, to be captured in the rectangular area marked for scanning according to the magnification and captured image resolution;
Marking the actual initial position to therefore move the scanner X and Y position on the slide;
Causing the microscope stage to move in Z direction in steps to therein capture multiple images at different Z positions;
Computing the optimum sharpness of the images and sets the Z movement at the most focused position;
Saving the captured image in memory of the computer in a shared folder with its corresponding row and column position in the image name.
e) In accordance with the defined set of scanning parameters, causing at least one image to be captured from the microscope corresponding to the analysis area and magnification selected, therein saving the at least one image to a ready shared folder in memory of the computer with its filename corresponding to the scan position selected;
f) In accordance with logic of the executable software, causing the execution of a validation subroutine, said subroutine comprising the steps of—
Determining first, whether or not the current position is the Last X position to thereby move the motorized slide stage in Y direction in the event the determination is positive, and alternatively reverting to the basal program if said determination is negative.
Determining first, whether or not the current position is the Last Y position to thereby read the image from shared folder of the computer in the event the determination is positive, and alternatively reverting to the basal program if said determination is negative.
g) Upon the sequential determinations in step f) being positive, preprocessing the image from the shared folder by smoothening said at least one image for removal of noise.
h) Identifying contours in said at least one image, therein selecting contours of same gray value variation to form contour groups and determining, among said contour groups, the best contours on basis of the predefined parameters for object identification, in a downstream process comprising—
Once objects are identified, computing feature data corresponding to said objects on basis of their size, shape, color, and texture;
Applying at least one filter on basis of size, sharpness, and agglomeration to the feature data generated to remove artifacts and result in filtered object data;
Determining whether the filtered object data corresponds to objects present on the left and top boundaries of the image under processing, and based on this determination, causing the execution of a suitable sub-process for resulting in either between boundary particle identification and particle classification respectively;
Determining whether the image being processed is the last image of total fields, and based on this determination, causing the execution of a suitable sub-process for either between termination with computation of result statistics and termination of the execution of the executable software upon reaching threshold of the user-defined parameter values respectively.
i) In accordance with logic of the executable software, causing the execution of a validation subroutine to determine whether or not the image being processed is last image of total fields to thereby allow the executable software to compute and present the result statistics of the analysis undertaken in the event said determination is positive, and alternatively repeating steps g) to h) until a discernable accurate resultant image is obtained.

2. The photomicrographic image-processing method for automatic scanning, detection and classification of particles present in a sample presented for photomicrography according to claim 1, wherein the executable software is provisioned for execution on the computer by either between a standalone installation and online access from a cloud server in a software-as-a-service model.
